(19) United States
(12) Patent Application Publication
(10) Pub. No.: US 2003/0218939 A1
(43) Pub. Date: Nov. 27, 2003

(54) Deployment of downhole seismic sensors for microfracture detection

(75) Inventors: Jose R. Casarsa, Houston, TX (US); Terry R. Bussear, Round Rock, TX (US); Michael W. Norris, Cypress, TX (US); Dean J. Fanguy, Houma, LA (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX

(21) Appl. No.: 10/351,928

(22) Filed: Jan. 27, 2003

Related U.S. Application Data
(60) Provisional application No. 60/352,603, filed on Jan. 29, 2002.

(51) Int. Cl. G01V 1/00

(52) U.S. Cl. 367/35

(57) ABSTRACT

Methods and equipment are described for placement of an array of seismic sensor sets along a horizontal section of wellbore for monitoring microseismic activity during and after hydro-fracturing. A perforated wellbore liner is positioned in the horizontal wellbore production section with sonic transmission enhancement devices such as longitudinal blade centralizers for acoustically coupling seismic sensing devices to the production formation. Internally of the perforated liner, a coiled tube is placed having an array of signal cable connected seismic sensor sets. The seismic sensor sets are linked to the coiled tube wall by sonic transmission enhancement devices and the tube wall linked by acoustic transmission enhancement devices to the perforated liner.

### CROSS-REFERENCE TO RELATED PRIOR APPLICATIONS

The present application is derived from U.S. Provisional Application Serial No. 60/352,603 filed Jan. 29, 2002 and claims all corresponding priority rights and privileges.

### BACKGROUND OF THE INVENTION

1. Field of the Invention

The present invention relates to the industrial arts of subterranean well drilling. More particularly, the invention is directed to methods and apparatus for conveyance of a seismic array for detecting and recording microseismic activity received along a substantially horizontal wellbore

2. Description of Related Art

Production from an oil or gas bearing formation is often enhanced by induced fracturing of the rock that encapsulates the fluid minerals. There are numerous methods of formation fracturing. However, one significant method comprises high pressure “water” injection. In essence, water injection includes a procedure for injecting water or an engineered aqueous fluid below or into an oil bearing formation under magnitudes of extreme pressure that exceed the rock fracturing pressure.

Applied to the field production of a large area, multiple wells are drilled into a producing formation in a matrix pattern. A portion of such wells may be injection wells. Other wells in the matrix may be producing wells. As production continues, some producing wells may be converted to injection wells and conversely, some injection wells may be converted to producing wells.

To maintain overall field production efficiency, it is desirable to monitor the location, trends and degree of formation fracturing. Traditionally, such monitoring is accomplished by highly developed methods of seismic sensing, recording and analysis. Preferably, the monitoring is an ongoing practice with the seismic sensors positioned permanently or semi-permanently in formation penetrating wellbores. When the wellbores are vertical and susceptible to cement injection, the sensors may be cemented in place to provide an effective acoustic coupling with the formation structure. However, if cemented in place, the sensors are neither retrievable nor replaceable.

Due to more recently developed well drilling equipment and techniques, wellbores may be turned to extend great distances through a substantially horizontal formation between relatively narrow bedding planes. Seismic sensor coupling to the formation structure by means of cementing is essentially precluded by the horizontal lay of the wellbore.

Although a retrievable array of seismic sensors may be placed in a vertical well by wireline, the acoustic coupling to the formation structure is mechanically challenging. Moreover, the sensors and trailing signal cable cannot be readily turned into a horizontal bore section. Hence, it is necessary to rely upon a self-contained, microseismic acquistion and recording unit having only a 24 hour, for example, recording capacity.

### SUMMARY OF THE INVENTION

One objective of this invention therefore is provision of equipment and deployment methods for positioning an array of seismic sensors in a horizontal section of wellbore and enhancing the acoustic coupling of the array to the formation structure. An additional object of the invention is equipment for a method of retrieving an acoustically coupled seismic sensor array for repair and replacement.

Also an objective of this invention is a method of monitoring microseismic activity during and after hydro-fracturing a long, horizontal wellbore. Another invention objective is the installation of a multiplicity of seismic sensor sets (e.g. individual or combinations of three-axial (three-axis) geophones, hydrophones, multi-axis accelerometers and the associated support hardware in a long, substantially horizontal segment of wellbore deep within the earth. Also an object of the invention is a method for enhancing the acoustic coupling of seismic sensors to a deep earth formation penetrated by a horizontal or highly deviated wellbore.

Representatively, an application of the invention may include an earth-bored well having a depth of about three kilometers, for example. Additional wellbore length may include an additional three kilometers of horizontal production bore. Typically, such a well may be completed with a 9″ bottom-hole casing that supports a 7″ slotted liner and a 5½″ production tube. Bottomhole well conditions may be in the order of 4200 psi and 85° C., for example. If a water injection well, the bottomhole pressure may be in the order of 5900 psi, for example.

The general concept of the invention includes the alignment of blade or fin centralizers for enhancing the acoustic coupling of seismic wave sensing devices such as geophones to the surrounding formation structure. Inclusively, centralizers are secured to a fluid permeable tube such as a perforated or slotted wellbore liner. The liner centralizers are attached to the perforated tube at exterior locations along the liner length corresponding to seismic sensor locations that are specified for the survey objective. These casing or liner centralizers make intimate contact with the raw, wellbore wall and, hence, with the formation structure. Seismic sensors such as geophone modules and signal cable are secured within appropriate continuous tubing for downhole placement within the well liner. The geophones are spaced along the tubing length at the specified locations that correspond to the liner centralizers. The geophones are then acoustically coupled to the interior tubing wall. One mode of acoustic coupling enhancement includes blade centralizers that are secured to the exterior wall of the continuous tubing in substantially radial alignment with the geophones positioned within the internal bore of the continuous tube. This alignment of centralizers allows the geophones to measure and spacially locate the position of seismic wave generation activity within a reservoir formation.

Typically, a slotted or perforated liner is run into the well with associated centralizers secured to the outer surface of the liner. These centralizers are placed at the locations desired for the corresponding geophone spacing. The slotted liner also includes a liner hanger/packer and a tie-back receptacle. After the liner is positioned and the liner hanger is set, a coiled tube and/or coupled pipe containing the geophones, cooperative signal cable and centralizers is run into the well for a distance corresponding to the geophone array length or length of the horizontal well section. The geophones and associated centralizers are positioned along the coiled tube length to correspond with the external liner centralizers.

While holding the upper end of the coiled pipe enclosing the geophone array within the well at the well derrick platform, a joint of well fluid production pipe is positioned for running into the well alongside the geophone array tube. By means of well known parallel flow tube appliances, the upper end of the geophone array tube is secured to the production pipe. The parallel flow tube may be arranged for secure connection with the liner hanger/packer and provide a pressure tight aperture for the geophone array tube and the production tube past a pressure opposing bulkhead.

The parallel flow tube may also be a benchmark for coordination alignment of the slotted liner centralizers with the geophone array tube centralizers whereby connection of the parallel flow tube to the liner hanger/packer physically coordinates alignment of the liner centralizers with the geophone array tube centralizers.

### BRIEF DESCRIPTION OF THE DRAWINGS

For a thorough understanding of the present invention, reference is made to the following detailed description of the preferred embodiments, taken in conjunction with the accompanying drawings in which like reference characters designate like or similar elements throughout the several figures of the drawing. Briefly,

FIG. 1 is a wellbore assembly schematic having representation for many of the important elements respective to a first embodiment of the invention.

FIG. 2A is a schematic wellbore assembly respective to an incompletely aligned second embodiment of the invention.

FIG. 2B is a sectioned detail of the second invention embodiment.

FIG. 3A is a schematic wellbore assembly respective to an incompletely aligned third embodiment of the invention.

FIG. 3B is a sectioned detail of the third invention embodiment.

FIG. 4A is a schematic wellbore assembly respective to an incompletely aligned fourth embodiment of the invention.

FIG. 4B is a sectioned detail of the fourth invention embodiment.

FIG. 5A is a schematic wellbore assembly respective to an incompletely aligned fifth embodiment of the invention.

FIG. 5B is a sectioned detail of the fifth invention embodiment.

### DESCRIPTION OF THE PREFERRED EMBODIMENTS

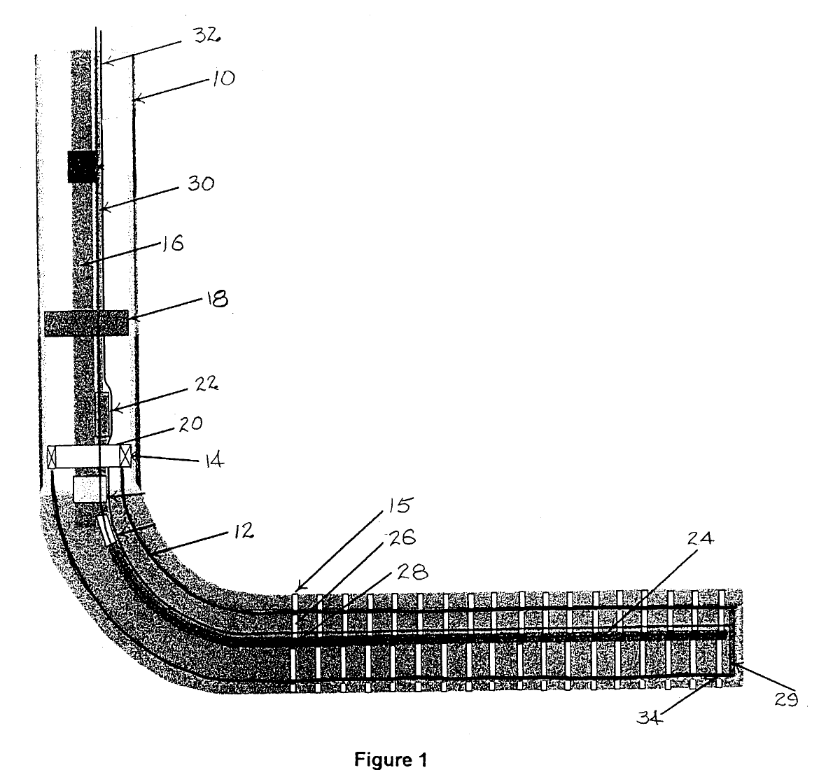

A first embodiment of the invention is represented schematically by FIG. 1 and comprises a wellbore casing 10 that is customarily secured to the raw wall of the surrounding wellbore by cement. Near the bottom end of the casing 10, a slotted or perforated well liner 12 is secured to the inside wall of the casing 10 by means of a liner hanger/packer 14. Although hereafter referred to as a slotted liner, comprehensively, the element 12 is a fluid permeable tube or fluid production screen of any suitable form. The slotted liner may be extended beyond the bottom end of the casing between horizontal bedding planes of a petroleum production formation or a water injection strata, for example.

Distinctively, the slotted liner 12 includes a plurality of centralizers 15 at precisely located positions along the liner length. These centralizers may consist of longitudinally or helically aligned fins that are intimately secured to the liner 12 outer surface. Importantly, these centralizing fins 15 should also be structurally sufficient to support the liner weight along a horizontal formation boring. Additionally, the centralizing fins 15 should make intimate support contact with the formation structure to provide an enhanced acoustic transmission coupling with the formation.

A seismic sensor array assembly (cabling, seismic sensor sets, connectors and associated electronics) 24 is assembled within a coiled tube of sufficient buckling strength, 4.5 in. nominal diameter, for example, to be pushed into position along the inner bore of the slotted liner 12. The seismic sensors may include tri-axial geophones 28, for example, which are positioned along the internal length of the coiled tube with longitudinal spacing that corresponds with the spacing between the plurality of liner centralizers 15. A seismic sensor set is an instrumentation package that senses seismic particle motion and provides ancillary measurements at a point or for a limited spatial extent. A sensor set may contain multi-axis sensors such as geophones or accelerometers along with an acoustic pressure sensor but can also include electronics, power and ancillary sensors such as temperature, inclination and orientation sensors. Each of the seismic sensor sets (e.g. tri-axial geophones) is secured at the specified location; preferably by a fluid impermeable method such as swaging or crimping. The tube may also be filled with seawater or oil. Also, each geophone 28 is provided intimate acoustic contact with the interior wall of the coiled tube housing. Centralizing fins 26 are intimately attached to the exterior wall of the coiled tube housing in radial alignment with each geophone 28. The centralizing fins 26 may be similar to the liner fins 15 such as longitudinally or helically oriented blades that project radially from the coiled tube surface out to intimate seismic contact with the interior wall surface of the slotted liner 12.

The lower end of the geophone array 24 is terminated with a hydraulically set anchor 29 having a shear release capacity. Additionally, the distal end of the array tubing includes a profile locator 34 to centralize the tubing end within the slotted liner.

The upper end of the coiled tube housing for the geophone array 24 is terminated by a connector housing 22. Signal transmission carriers respective to each geophone 28 in the array 24 are accommodated by dedicated splice pins within the connector housing 22. The housing is fluid pressure tight to prevent electrical disruption of the geophone signals.

The geophone array 24 is suspended within the wellbore casing 10 for incremental assembly into the open wellhead. Supporting the array is a traveling block, not illustrated, supported from the crown of a derrick, also not illustrated. The first section of the geophone array is provided with the tubing anchor mechanism 29 and profile/locator 34. Successively, the coiled tube housing with pre-installed geophones 28 is lowered into the well in increments as centralizers 15 are secured to the exterior surface of the coiled tube housing. The final or upper section of the geophone array 24 is secured to the parallel flow tube assembly 20, along with the first joint of production tubing string 16. A connector housing 22 is installed above the parallel flow assembly 20. Once it reaches the liner hanger/packer depth, the parallel flow tube assembly and the lower end of the production tube 16 connect with the liner hanger/packer 14 with a pressure tight fit to both production tube 16 and geophone array 24. Fluid sealed apertures (penetrations) for hydraulic control lines 32 may also be accommodated by the parallel flow tube 20.

The surface connected segment of the geophone signal cable is connected to the signal carrier splice pins within the connector housing 22 and threaded internally through a reel-laid, continuous tube conduit 30. The cable conduit 30 is secured and sealed to the connector housing 22. Subsequently, as successive joints of production tubing 16 are added to the descending workstring, parallel segments of the cable conduit 30 are externally secured to the production tubing string by banding.

Above the connector housing 22, a tubing anchor 18 is attached to the production tube string 16 to relieve the liner hanger/packer 14 of supporting the production tube 16 weight when the production string is ultimately released from the supporting derrick. This tubing anchor 18 transfers all or a portion of the production tube 16 weight directly to a segment of the casing 10. Depending on the well depth, there may be more than one tubing anchor.

This unitized assembly is progressively lowered into well with the seismic sensor array 24 passing through the open liner hanger/packer 14 into the interior of the slotted liner 12. The seismic sensor array 24 is thereafter pushed along the slotted liner interior until the parallel flow tube 20 attached to the production tube 16 and geophone array 24 engages the liner hanger/packer 14. The parallel flow tube 20 is sealed and secured to the liner hanger/packer in a manner well known to the prior art. The profiled locator 34 is engaged to center the end of the array 24 within the slotted liner 12 and the tubing anchor 29 is set.

The secured and sealed interface between the parallel flow tube 20 and the liner hanger/packer 14 may be a mutual bench-mark for locating both, the slotted liner centralizers 15 and the geophone array centralizers 26. Resultantly, a substantially solid, acoustically coupled linkage may be erected between each geophone and the formation structure. From this solid linkage, microseismic data from the formation may be accumulated as the formation is fractured for production enhancement and/or subsequently as the formation is produced or injected.

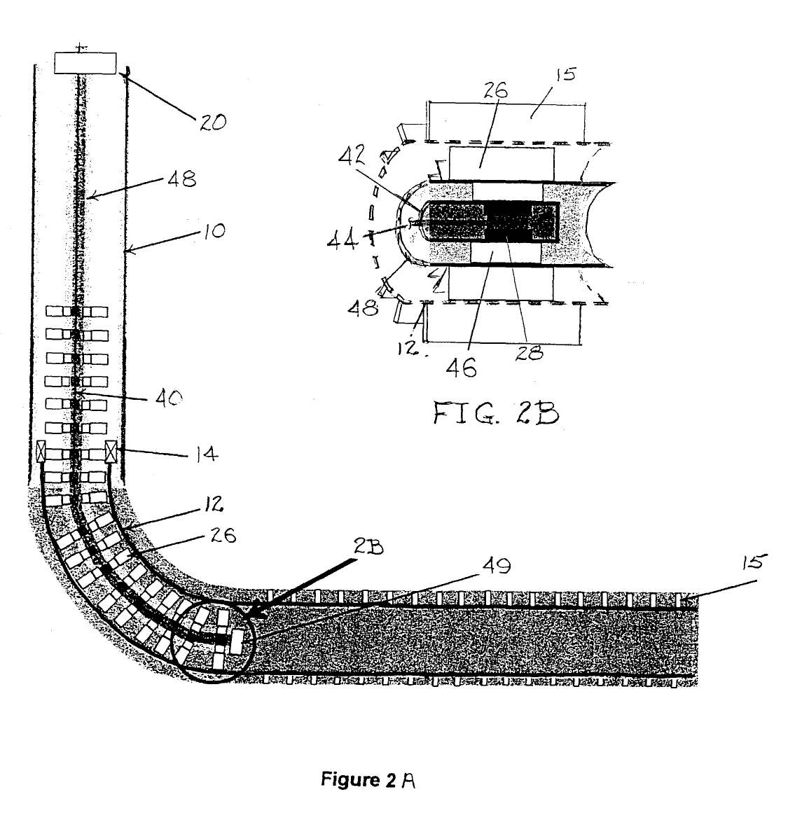

A second embodiment of the invention is represented schematically by FIGS. 2A and 2B and is characterized by a seismic sensor array comprising a small, 1¾″ for example, continuous sheathing 42 of coiled tube for the geophones 28. The axial locations of the geophones is secured within the internal bore of the fluid filled tube 42 at respective, specified positions by swaging or crimping. Longitudinal or helically oriented centralizing fins 46 are secured to the exterior surface of the tube 42 in alignment with the geophones.

Corresponding substantially to the length of horizontal well bore to be serviced, a length of larger diameter, 3½″ nominal diameter for example, threaded and coupled pipe 48 is suspended in the well from the derrick. Preferably, the distal end of the coupled pipe string is sealed by a plug 49. With respect to FIG. 2B, longitudinal or helical centralizing fins 26 are secured to the external surface of the coupled pipe string at the specified positions along the pipe string 48 length. While suspended from the derrick floor, the geophone tube sheath 42 is inserted into the bore of the larger, coupled pipe string 48.

The coupled pipe string 48 and enclosed geophone tube sheath 42 are secured to a parallel flow tube 20 to facilitate a sealed barrier transition past the liner hanger/packer 14. The uppermost ends of the geophone tube sheath 42 and coupled pipe string 48 are terminated at an electrical splice housing above the parallel flow tube assembly 22. The parallel flow tube 20 is also secured to the lowermost section of a 5½″ production tube 16, for example.

A small diameter continuous tube, 1¾″ nominal for example, may be secured with a pressure sealed fit to the upper end of the splice housing 22. This 1¾″ continuous tube shields the geophone signal carrier cable from the hostile well environment up to the surface. As joints of production tube 16 are added to the workstring, the coupled pipe string 48 is incrementally banded to the more structurally substantial production tube 16.

The workstring development and wellbore run-in is continued as described above until the parallel flow tube 20 engages the liner hanger/packer 14. Here, the parallel flow tube 20 is secured and sealed to the liner hanger/packer. At this point, the geophones 28 should be in radial alignment with the centralizers 15 that radiate from the outer surface of the slotted liner 12.

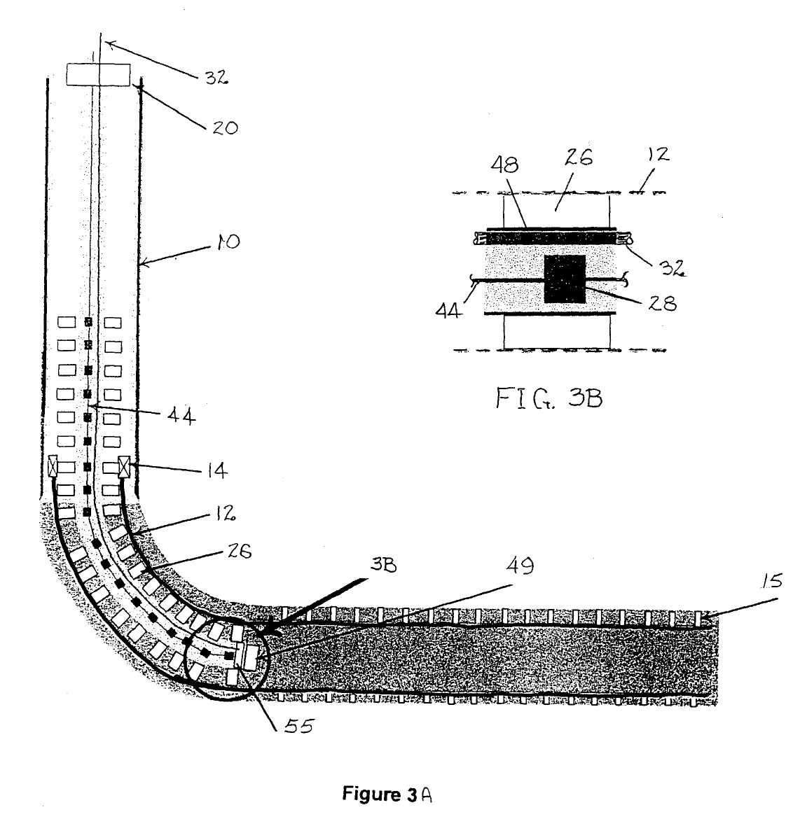

A third embodiment of the invention is schematically represented by FIGS. 3A and 3B. For this embodiment, vertical wellbore casing 10 is set and slotted liner 12 having centralizers 26, is run into a horizontal wellbore along the formation of interest as described relative to the embodiments of FIGS. 1 and 2A. The slotted liner 12 is secured to the casing by a liner hanger/packer 14. From the derrick floor, threaded and coupled pipe, 3½″ nominal diameter for example, is run into the vertical wellbore section for a distance corresponding to the length of the horizontal wellbore section. Preferably, this coupled pipe string 48 is closed at its distal end by a pipe plug 49.

Outside of the wellbore, the seismic sensor array is assembled and secured to the bottom of a small diameter, 1″ for example, coiled tube. The intended distal end of the coiled tube is provided with a remotely actuated, detachable anchor 55 to which the geophone array is attached. Hydraulic control conduit 32, for example, may be drawn along the 1″ coiled tube with the connected geophones 28 for actuating the anchor 55.

This coiled tube sheath and geophone array is then pushed into the bore of the vertically suspended, coupled pipe string and the geophones 28 longitudinally aligned with the coupled pipe centralizers 26. The geophone array anchor is set, the coiled tube is detached from the anchor and drawn out of the well over the seismic sensor array thereby leaving the seismic sensor array openly distributed along the internal length of the coupled pipe 48.

As the coiled tube sheath is withdrawn from the coupled pipe bore, a fluidized mixture of waterblock material is pumped through the coiled tube bore into the coupled pipe bore. The coupled pipe bore is filled to capacity. A common formulation of suitable waterblock material includes a mixture of seawater and sodium silicate. When set, the waterblock material becomes extremely stiff, albeit flexible, and constitutes a suitable seismic wave couple between the seismic sensors 28 and the coupled pipe wall 48. Certain formulations of such waterblock provide amber-like properties.

The upper end of the coupled pipe 48 is secured within a parallel flow tube 20. The parallel flow tube is also attached to a 5½″ production tube, for example. The upper end of the coupled pipe 48 is reduced to structurally connect the lower end of the withdrawn 1″ coiled tube having the vertical section of the geophone signal cable 44 continuing up the bore. Consequently, the 1″ coiled tube becomes the external armor for the geophone signal cable.

The assembly is completed by strapping the coiled tube to the string of production tube as each joint is added. Assembly of the parallel flow joint 20 with the liner hanger/packer 14 benchmarks the geophones 28 with the slotted liner centralizers 26.

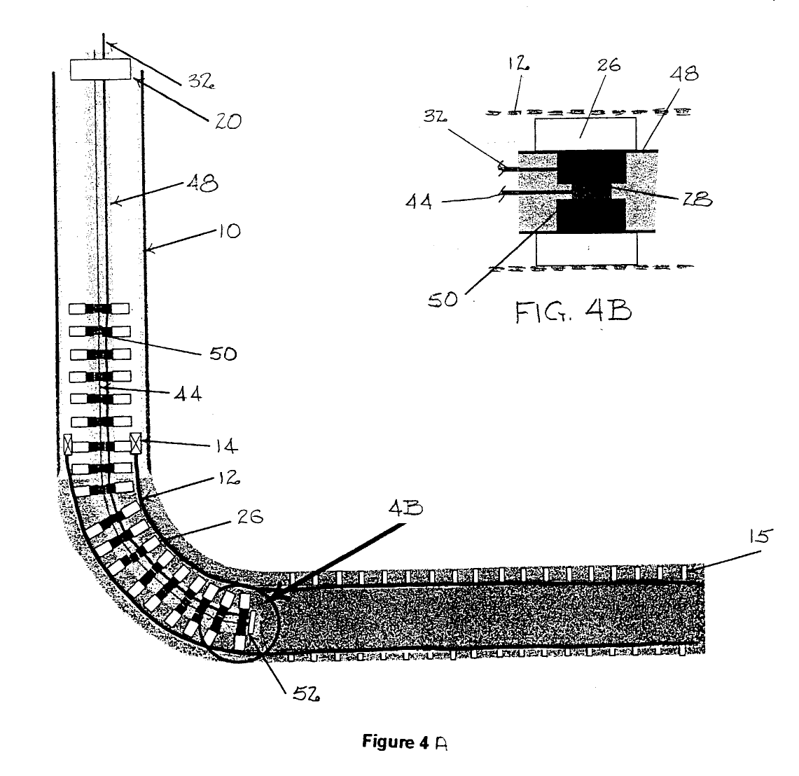

A fourth permutation of the invention is schematically represented by FIGS. 4A and 4B. As in the previous embodiments, the casing 10 is set and the slotted liner 12 with centralizers 15 secured in a horizontal wellbore section by a liner hanger/packer 14 that can accommodate a parallel flow tube 20 around a 5½″ production tube, for example, and a 3½″ threaded and coupled pipe string 48.

In this embodiment, the horizontal run length of coupled pipe string 48 is suspended into the wellbore from the derrick floor while the assembled seismic sensor array is hydraulically pumped into the coupled pipe string behind a pump-down plug 52. Each geophone 28 is provided with a dedicated tubing anchor 50 deployed either hydraulically or electrically. The tubing anchors 50 are retracted until the array is aligned with corresponding centralizers 26. When activated, the anchors 50 provide seismic signal continuity from the formation to the seismic sensors.

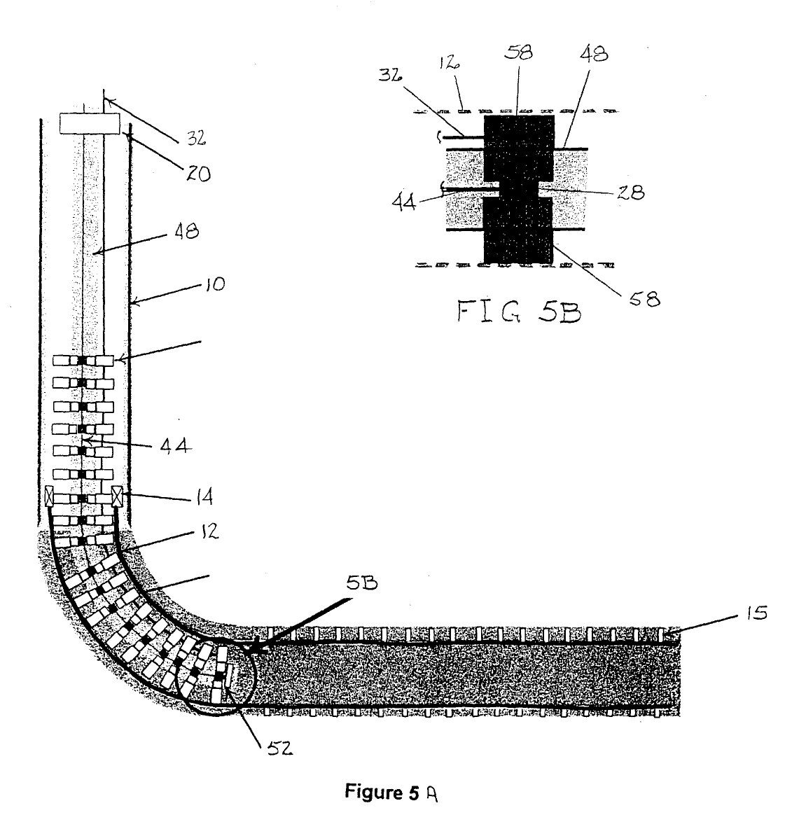

The fifth invention embodiment of FIGS. 5A and 5B is similar to the apparatus and method of FIG. 4 except that the dedicated anchor assemblies 58 are attached to the 3½″ coupled pipe string 48, for example. Using either a 1″ coiled tube to unitize the geophone assembly for the placement of geophone sensors within the coupled pipe string or, a wash-down plug 52, the seismic sensors are positioned within the coupled pipe string 48 adjacent to the respective anchor assemblies 58 while the coupled pipe string 48 is suspended in the wellbore from the derrick floor. The upper end of the coupled pipe string 48 is assembled with the lower end of a 5½″ production string 16, for example, by means of parallel flow tube 20 and continued into the wellbore. As additional pipe joints are added to the production string 16, a continuous armored signal cable extended from the sealed upper end of the coupled pipe string 48 is incremently strapped to the production string 16. When the parallel flow tube 20 is secured and sealed to the liner hanger/packer 14, the anchor assemblies 58 are actuated.

Although the invention has been described in terms of particular embodiments which are set forth in detail, it should be understood that this is by illustration only and that the invention is not necessarily limited thereto. Alternative embodiments and operating techniques will become apparent to those of ordinary skill in the art in view of the present disclosure. Accordingly, modifications of the invention are contemplated which may be made without departing from the spirit of the claimed invention.

1. A seismic sensor system comprising:
(a) an earth formation penetrated by a wellbore;
(b) a plurality of seismic sensor sets distributed at specified positions along the length of said wellbore; and,
(c) enhanced acoustic transmitters positioned between said sensors and said earth formation.

2. A seismic sensor system as described by claim 1 wherein said seismic sensor sets are distributed within a wellbore liner having acoustic transmission enhancement devices linking said wellbore liner and said earth formation proximate of said specified positions.

3. A seismic sensor system as described by claim 1 wherein said seismic sensor sets are disposed within a housing tube having acoustic transmission enhancement devices linking said housing tube and said wellbore liner proximate of said specified positions.

4. A seismic sensor system comprising:
(a) a wellbore liner having a first longitudinal benchmark appliance and a first plurality of acoustic coupling devices distributed along the length of said liner relative to said benchmark, said first acoustic coupling devices being effective to enhance acoustic transmissions from an earth formation; and,
(b) a tubular housing for longitudinal disposition within said liner, said tubular housing having a second longitudinal benchmark appliance and a second plurality of acoustic coupling devices distributed along the length of said tubular housing relative to said second longitudinal benchmark appliance, said second acoustic coupling devices being effective to enhance acoustic transmission from said wellbore liner to corresponding sonic receivers positioned within said tubular housing when said second benchmark appliance substantially aligns with said first benchmark appliance.

5. A seismic sensor system as described by claim 4 wherein
said first benchmark appliance is a liner hanger for securing said liner to a well casing.

6. A seismic sensor system as described by claim 5 wherein
said second benchmark appliance is a parallel flow tube for securing said tubular housing to said liner hanger.

7. A seismic sensor system as described by claim 6 wherein
said parallel flow tube further accommodates a formation fluid production tube.

8. A method of positioning an array of seismic sensor sets in a wellbore comprising the steps of:
(a) acoustically coupling a wellbore tube to an earth formation at specified locations;
(b) distributing an array of seismic sensor sets at locations along the length of a sensor housing tube corresponding to the specified locations along said wellbore tube;
(c) positioning said sensor housing tube within said wellbore tube; and,
(d) acoustically coupling said seismic sensor sets to said wellbore tube.

9. A method of positioning an array of seismic sensors as described by claim 8 wherein said wellbore tube is acoustically coupled to said earth formation by first acoustic transmission enhancement devices.

10. A method of positioning an array of seismic sensor sets as described by claim 9 wherein said first acoustic transmission enhancement devices are liner position centralizers secured to said wellbore tube.

11. A method of positioning an array of seismic sensors as described by claim 10 wherein said sensor housing tube is acoustically coupled to said wellbore tube by second acoustic transmission enhancement devices.

12. A method of positioning an array of seismic sensors as described by claim 11 wherein said second acoustic transmission enhancement devices are position centralizing fins secured to said sensor housing tube.

13. A method of positioning an array of seismic sensors as described by claim 11 wherein said seismic sensor sets are acoustically coupled to said housing tube by third acoustic transmission enhancement devices.

14. A method of positioning an array of seismic sensor sets in a wellbore comprising the steps of:
(a) securing seismic wave transmitting centralizers to the exterior surface of a wellbore liner tube at specified locations along the liner tube length displaced from a liner benchmark;
(b) securing seismic wave sensors at specified locations along the length of a sensor housing tube displaced from a housing benchmark;
(c) securing seismic wave transmitting centralizers to the exterior surface of said sensor housing tube in cooperative alignment with said sensors;
(d) placing said wellbore liner tube within a wellbore;
(e) placing said sensor housing tube within said wellbore liner; and,
(f) coordinating said housing benchmark with said liner benchmark to align the housing centralizers with said liner tube centralizers for enhancing the transmission of seismic waves striking said wellbore to said sensors.

15. A method of positioning an array of seismic sensors in a wellbore as described by claim 14 wherein said wellbore liner tube is a perforated production screen.
